(19) United States
(12) Patent Application Publication
(10) Pub. No.: US 2026/0106728 A1
(43) Pub. Date: Apr. 16, 2026

(54) INTEGRITY-PROTECTION AUTHENTICATION THROUGH INTERMEDIATE STATES

(71) Applicant: CRYPTOGRAPHY RESEARCH, INC., San Jose, CA (US)

(72) Inventors: Ajay Kapoor, Eindhoven (NL); Cezar Rodolfo Wedig Reinbrecht, Berkel-Enschot (NL)

(21) Appl. No.: 19/119,218

(22) PCT Filed: Oct. 10, 2023
(86) PCT No.: PCT/US2023/034845

§ 371 Date: Apr. 8, 2025

Related U.S. Application Data
(60) Provisional application No. 63/416,826, filed on Oct. 17, 2022.

(51) Int. Cl. H04L 9/06; G06F 21/64; H04L 9/32

(52) U.S. Cl. CPC H04L 9/0643; G06F 21/64; H04L 9/3242

(57) ABSTRACT

Technologies for protecting data integrity of an authentication algorithm using intermediate states are described. One inline memory encryption (IME) engine performs an authentication algorithm that uses a hash function to compute an authentication tag. The IME engine includes integrity-protection logic to store an intermediate state of a tag computation and incoming data segments. In the event of an error in the computation, the integrity-protection logic can compute the intermediate state again using a last intermediate state and the last data segment.

### BACKGROUND

Modern computer systems generally include one or more memory devices, such as those located on a memory module. The memory module may include, for example, one or more random access memory (RAM) devices or dynamic random access memory (DRAM) devices. A memory device can include memory banks made up of memory cells that a memory controller or memory client accesses through a command interface and a data interface within the memory device. The memory module can be a persistent memory module with one or more non-volatile memory (NVM) devices.

Data authentication is becoming a key requirement for memory. Some applications can experience frequent, random error occurrences during operation. Some memory systems need to be equipped to perform instantaneous error detection operations, sometimes referred to as data integrity (DI) detection or DI checkers. Conventional authentication techniques, in the case of an error being detected by the DI checker, restart the authentication process of the packets from the start due to the chaining nature of the tag computation. The conventional authentication techniques cause an entire data packet to be re-transmitted for re-computing an authentication tag. This increases computational effort (i.e., more memory accesses and more power consumption) and, more importantly, latency to re-transmit the data and re-compute the authentication tag.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of an inline memory encryption engine with integrity-protection logic for protecting data integrity of authentication through intermediate states according to at least one embodiment.

FIG. 2 is a block diagram illustrating an authentication iteration of an authentication algorithm using integrity-protection logic according to at least one embodiment.

FIG. 3 is a block diagram illustrating multiple authentication iterations of an authentication algorithm using integrity-protection logic according to at least one embodiment.

FIG. 4 is a block diagram illustrating an authentication iteration of an authentication algorithm with multiple authentication units and integrity-protection logic according to at least one embodiment.

FIG. 5 is a block diagram illustrating an authentication iteration of an authentication algorithm with multiple authentication units and integrity-protection logic with an additional authentication unit according to at least one embodiment.

FIG. 6 is a block diagram of integrity-protection logic according to at least one embodiment.

FIG. 7 is a block diagram of integrity-protection logic according to at least one embodiment.

FIG. 8 is a flow diagram of a method of storing and using intermediate states to protect the integrity of an authentication algorithm according to at least one embodiment.

FIG. 9 is a flow diagram of a method of storing and using intermediate states to protect the integrity of an authentication algorithm according to at least one embodiment.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Data authentication is becoming a key requirement for memory, especially for inline memory encryption (IME). Data authentication can be achieved by splitting memory into different sectors, where each sector is authenticated by an authentication tag. One authentication algorithm is the Galois Message Authentication Code (GMAC) algorithm that uses a hashing function, called the GHASH function, to generate an authentication tag. A data access to memory can be done in a time-slice packetized manner, where each packet can be up to the size of a data burst (e.g., a double data rate (DRR) burst). Some applications have key drivers, such as higher reliability needs, regulatory needs, high-temperature environments, denser integration in technology advancements along with aging, low-voltage operation relying on approximate computing, or the like. These applications can experience frequent, random error occurrences during operation. These memory systems need to be equipped to perform instantaneous error detection operations, sometimes referred to as data integrity (DI) checkers or DI detectors.

As described above, conventional authentication techniques rely on restarting an authentication process or re-transmitting an entire data packet to re-compute an authentication tag in the case of an error event. For example, in the event of an uncorrectable error, a single error will restart the authentication of the packets from the start of the sector due to the chaining nature of the tag computation. For another example, in the event of an uncorrectable error in a packet of a sequence of packets for messages between a sender node and a receiver node, the entire sequence of packets needs to be re-transmitted to compute the authentication tag due to the chaining nature of the tag computation. The authentication algorithm can have multiple iterations, and if any error flag is triggered during one of the multiple iterations, the entire authentication process must start again from the beginning (e.g., a first part of a multi-part data sequence). This results in longer latency, more memory access, power consumption, and the like.

Aspects of the present disclosure and embodiments address these problems and others by providing a closed-loop authentication architecture that ensures limited data re-transmission in case of any detectable computation error in an authentication process. Aspects of the present disclosure and embodiments can perform error detection in any error-prone computation step, such as an encryption operation or computation, an authentication operation or computation, a static random access memory (SRAM) operation, an input/output (I/O) operation, or the like. Aspects of the present disclosure and embodiments can provide local storage for an intermediate state of a hash computation, along with an intermediate initialization vector (IV).

Aspects of the present disclosure and embodiments can activate a control loop at a time of error occurrence. In at least one embodiment, the control loop can signal a sender to re-send the packet (or a segment of the packet) corresponding to the error. In at least one embodiment, the control loop can hold off or prevent the sender from sending new packets (or new segments of the packet). In at least one embodiment, the control loop stores incoming packets (or segments) in a first buffer until the desired packet (or desired segment) arrives from the re-transmission. The control loop can store the last intermediate hash state computed without errors in a second buffer and resume the hash computation with the last intermediate hash state once the desired packet (or desired segment) arrives from the re-transmission. The control loop can continue the tag computation to empty the first buffer. The control loop can signal the sender that the first buffer is empty and resume normal packet transmission. In this embodiment, a first-in-first-out (FIFO) storage can be used, and the output data ordering is maintained.

In at least one embodiment, the control loop can determine an identification number (e.g., a sequence number), including a sequence count of the faulted packet. The control loop does not update the intermediate hash state corresponding to the faulted packet. The control loop can continue processing the incoming packets, as normal, with their corresponding identification numbers, updating the intermediate states, and sending out the encryption data. When the faulted packet re-arrives, the control loop can compute and update the intermediate state by considering the sequence number of the packet in the data sequence. In this embodiment, the control loop does not need the FIFO storage.

Aspects of the present disclosure and embodiments can use integrity-protection logic, also referred to as integrity-protection authentication through intermediate states (IPATIS), to ensure limited re-computation and reduced re-transmission (or no re-transmission) in the case of any detectable integrity error by exploiting the inherent intermediate states from authentication algorithms.

Aspects of the present disclosure and embodiments can save time by avoiding redoing authentication from the beginning or re-transmitting the data from the beginning. Aspects of the present disclosure and embodiments can save power by avoiding repeating the authentication or re-transmitting all of the data. Aspects of the present disclosure and embodiments can optimize storage usage, allowing already-used input to be dropped. Aspects of the present disclosure and embodiments can improve system memory life by reducing unnecessary accesses. The area and effort to store and manage an intermediate state are minimal. The intermediate state can be managed by software or hardware.

Aspects of the present disclosure and embodiments can achieve a performance improvement, including a reduction in the number of computations, bandwidth savings, and a reduction in latency, by storing intermediate states of the authentication tag computation. By storing and using the intermediate states, there is no need to restart the authentication tag calculation from the beginning if an error is detected. By storing and using the intermediate states, there is no need to re-transmit all packets if an error is detected. Aspects of the present disclosure and embodiments can provide a self-contained local solution without impacting the overall data flow in the system.

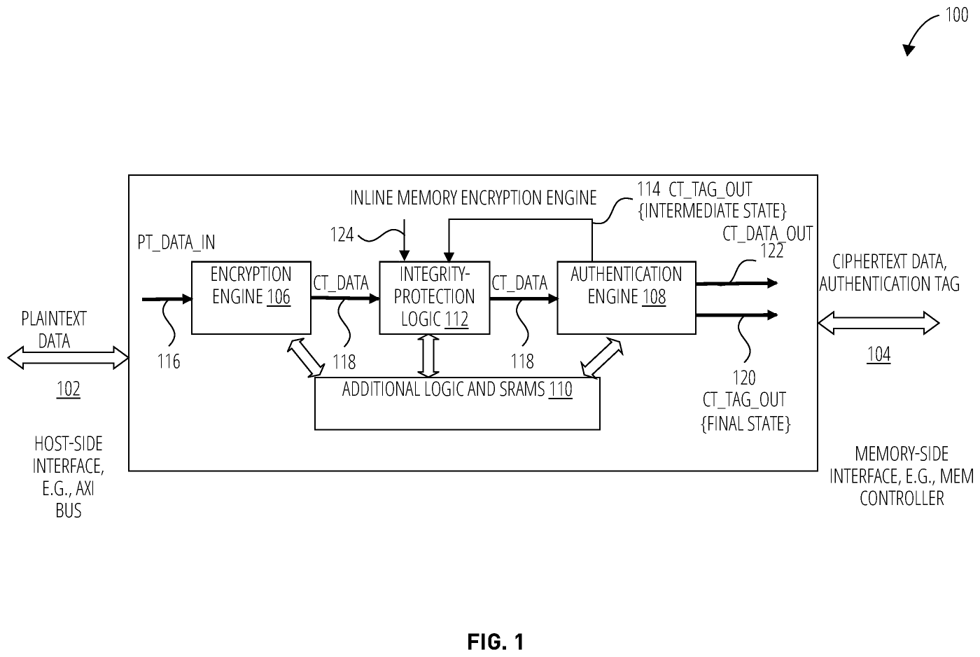

FIG. 1 is a block diagram of an inline memory encryption engine (IME) 100 with integrity-protection logic 112 for protecting data integrity of authentication through intermediate states according to at least one embodiment. The IME engine 100 provides encryption, decryption, and authentication for memory read and write requests between a host processor via a host-side interface and its attached memory via a memory-side interface. The IME engine 100 can be instantiated on a host system (e.g., System on Chip (SoC) or Field Programmable Gate Array (FPGA)) between the processor logic and a memory controller. The IME engine 100 can be a high-throughput, low-latency security solution. The IME engine 100 can be implemented in hardware, software, firmware, or any combination thereof. The IME engine 100 can receive plaintext data 102 over the host-side interface, encrypt the plaintext data 102 into ciphertext data, generate an authentication tag, and provide an output 104 to memory over the memory-side interface. The output 104 includes ciphertext data and the authentication tag. The IME engine 100 can receive ciphertext data and an authentication tag from the memory controller over the memory-side interface, decrypt the data, and provide the decrypted data over the host-side interface. The IME engine 100 can implement an encryption and authentication algorithm, such as the AES-GCM algorithm. The AES-GCM algorithm uses AES-256 for encryption and GMAC for authentication. The GMAC internally uses the GHASH functions to generate the authentication tag.

In at least one embodiment, the IME engine 100 includes an encryption engine 106, an authentication engine 108, and integrity-protection logic 112. In a further embodiment, the IME engine 100 includes additional logic and SRAMs 110 coupled to the encryption engine 106, the authentication engine 108, and integrity-protection logic 112. The additional logic and SRAMs 110 can be used to perform other operations and store information in connection with the encryption and authentication operations. The encryption engine 106 (also referred to herein as encryption logic) can receive the plaintext data 102 as segments (or portions) and encrypt the segments into segments (or portions) of ciphertext data. The encryption engine 106 can use AES-256 for the encryption. Instead of directly inputting the ciphertext data into the authentication engine 108 (also referred to as authentication logic), the integrity-protection logic 112 receives the ciphertext data from the encryption engine 106. The integrity-protection logic 112 can receive and store the intermediate state 114 computed by the authentication engine 108. The intermediate state 114 can include an intermediate hash state of a hash computation and an intermediate initialization vector (IV). The integrity-protection logic 112 can protect the data integrity of the authentication through intermediate states 114 computed by the authentication engine 108. The integrity-protection logic 112 can also store incoming data from the encryption engine 106. The integrity-protection logic 112 can provide the ciphertext data to the authentication engine 108 to generate an authentication tag in a chaining manner. The authentication engine 108 can use GMAC for authentication, including the GHASH function, to generate a final authentication tag. Before outputting the final authentication tag, the authentication engine 108 can output the intermediate state stored by the integrity-protection logic 112 in the event of an error, as described in more detail below.

In at least one embodiment, the encryption engine 106 (encryption logic) receives segments 116 of plaintext data 102 of a data burst and outputs segments 118 of cyphertext data of the data burst. The authentication engine 108 (authentication logic) receives the segments 118 of the cyphertext data, outputs an intermediate state 114 corresponding to a respective segment of the cyphertext data, and outputs a final authentication tag 120 associated with the data burst, along with the final ciphertext data 122. The integrity-protection logic 112 is coupled between the encryption engine 106 and the authentication engine 108. The integrity-protection logic 112 includes an intermediate state storage to store a copy of a last intermediate state computed by the authentication engine 108. The integrity-protection logic 112 includes a packet storage to store a copy of one or more segments 118 of the cyphertext data. The integrity-protection logic 112 can receive an indication of an error 124 associated with a current segment of the cyphertext data and cause the authentication engine 108 to re-compute a current intermediate state associated with the current segment using the last intermediate state and the current segment of the cyphertext data without the error.

In at least one embodiment, the IME engine 100 includes data-integrity (DI) detection logic to detect the error. The DI detection logic can be part of or coupled to the encryption engine 106. The DI detection logic can be part of or coupled to the authentication engine 108. The DI detection logic can be part of or coupled to the additional logic and SRAMs 110. In other embodiments, each stage of the IME engine 100 can include DI detection logic to detect errors in the authentication operations, encryption operations, SRAM operations, I/O operations, or the like. That is, the indication of an error 124 can be a result of a DI error in one or more of an encryption computation by the encryption engine 106, an authentication computation by the authentication engine 108, an SRAM operation by the additional logic and SRAMs 110, or an I/O operation.

In at least one embodiment, the integrity-protection logic 112 can hold sending an acknowledgment signal to a sender to indicate that a current authentication iteration is completed. The integrity-protection logic 112 can send a request to the sender to re-send the current segment. The integrity-protection logic 112 can send the acknowledgment signal to the sender responsive to a determination that the re-computation of the current intermediate state is completed.

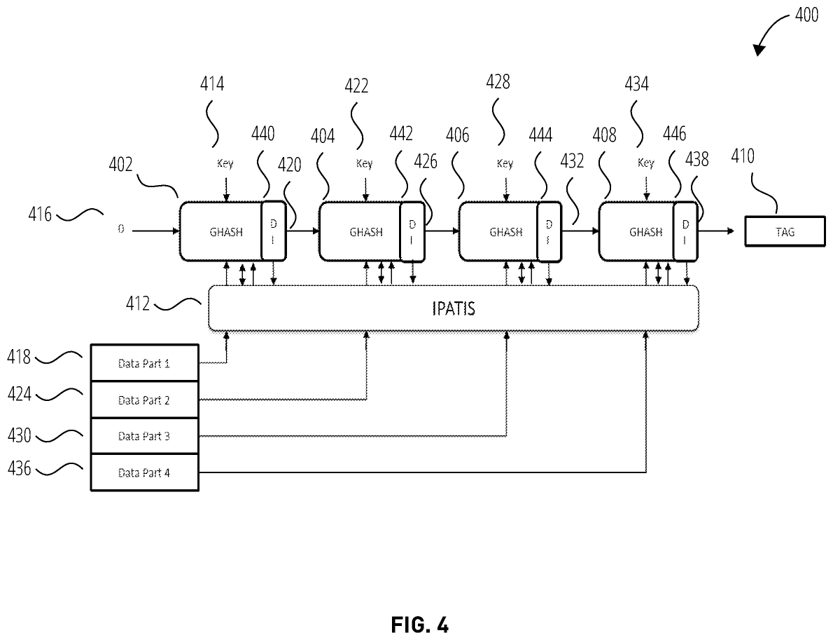

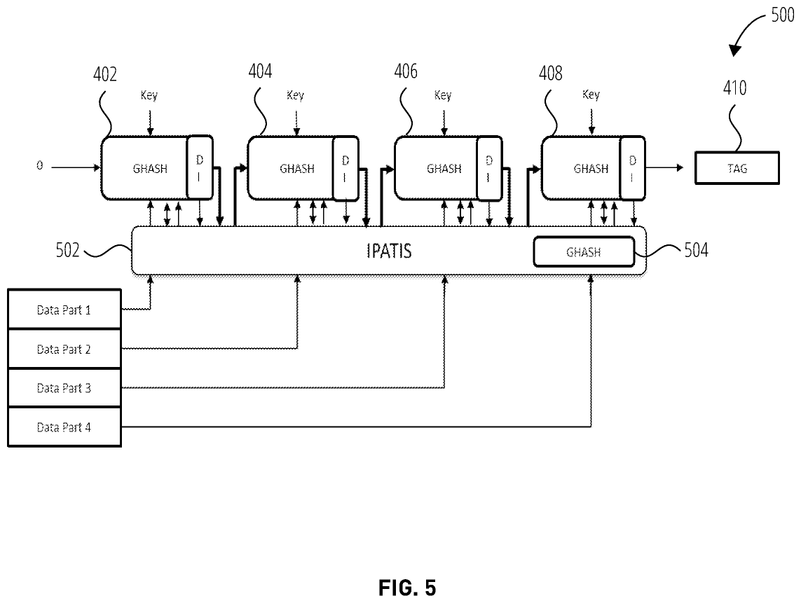

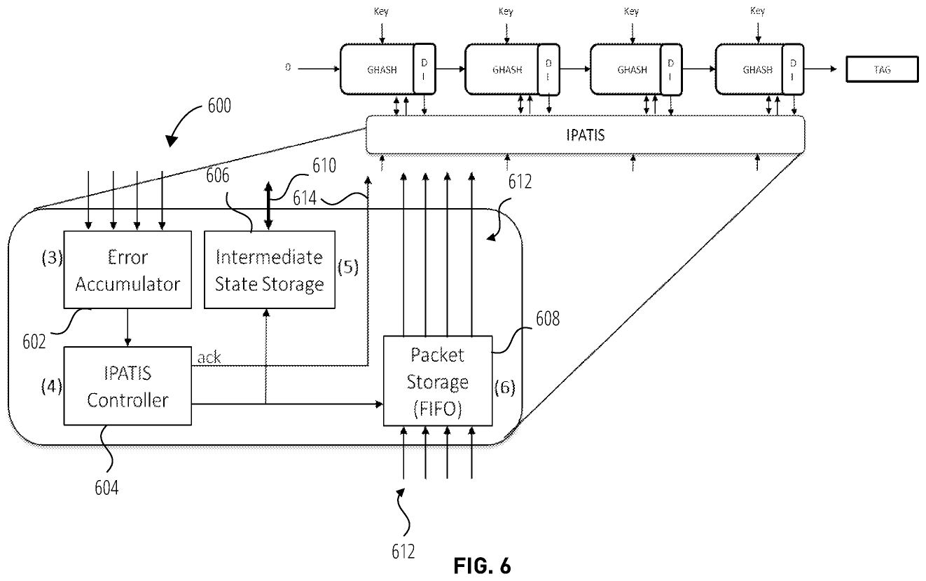

In at least one embodiment, the authentication engine 108 includes multiple authentication units, as illustrated in FIG. 4 and FIG. 6. Each authentication unit computes an intermediate state of a respective segment in an authentication iteration using an authentication function, such as the GHASH. In at least one embodiment, the integrity-protection logic 112 includes an additional authentication unit to re-compute the current intermediate state associated with the current segment using the last intermediate state and the current segment of the cyphertext data without the error, such as illustrated in FIG. 5.

In at least one embodiment, the IME engine 100 starts the generation of a Message Authentication code (MAC) tag with error detection from a sequence of packets received from a source node over the host-side interface. The IME engine 100 detects an error associated with a first packet in the sequence of packets. In at least one embodiment, the error can be a data integrity (DI) error in at least one of an encryption computation by the encryption engine 106, an authentication computation by the authentication engine 108, an SRAM operation by the additional logic and SRAMs 110, or an input/output (I/O) operation.

In response to detecting the error, the IME engine 100 continues the generation of the MAC tag without updating a first intermediate state corresponding to the first packet to produce a first result. The IME engine 100 stores a second intermediate state of the MAC tag corresponding to a second packet before the error. The IME engine 100 sends a request over the host-side interface to the source node to re-transmit the first packet. The IME engine 100 receives a third packet, a re-transmission of the first packet. The IME engine 100 continues the generation of the MAC tag with the third packet to produce a second result using the second intermediate state. The IME engine 100 calculates a final MAC tag from the first result and the second result.

In a further embodiment, the IME engine 100 determines an identification number of the packet in a sequence count for the sequence of packets. The IME engine 100 generates the request with the identification number of the packet to send the request to the source node to re-transmit the packet. The IME engine 100 continues processing incoming packets of the sequence of packets with their corresponding identification numbers and updating intermediate states corresponding to the incoming packets until the third packet arrives. The IME engine 100 processes the third packet and updates the first intermediate state by considering the identification number of the packet in the sequence of packets. In at least one embodiment, the IME engine 100 signals to the source node to hold off sending one or more subsequent packets in the sequence of packets. The IME engine 100 stores one or more intervening packets in a buffer until the third packet arrives. The IME engine 100 resumes a hash computation using the second intermediate state once the third packet arrives. The IME engine 100 continues the hash computation with the one or more intervening packets stored in the buffer. The IME engine 100 signals to the source node to continue sending the one or more subsequent packets in the sequence of packets once the one or more intervening packets are processed.

As illustrated in FIG. 1, the generation of the MAC tag is performed in connection with an authentication algorithm that uses a hashing function to compute the MAC tag. In other embodiments, the generation of the MAC tag is performed in connection with another operation, such as an encryption operation. In at least one embodiment, the authentication algorithm is the GMAC algorithm, and the hash function is the GHASH function. Alternatively, other authentication algorithms and/or hash functions can be used.

In another embodiment, the IME engine 100 is part of a receiver node operatively coupled to a sender node. The IME engine 100 stores a first portion of a data burst, received from the sender node, in a local storage. The IME engine 100 processes the first portion using an authentication algorithm to generate a first intermediate state. The authentication algorithm generates a final authentication tag for the data burst. The IME engine 100 stores the first intermediate state in the local storage, the first intermediate state being associated with the first portion. The IME engine 100 stores a second portion of the data burst, received from the sender node, in the local storage. The IME engine 100 processes the second portion using the authentication algorithm and the first intermediate state to generate a second intermediate state. The IME engine 100 detects an error in the processing the second portion. The IME engine 100 can indicate to the sender node that an error was detected in connection with the second portion and request that the sender node re-send the second portion. The IME engine 100 stores a re-transmitted second portion of the data burst, received from the sender node, in the local storage. The IME engine 100 re-processes the re-transmitted second portion using the authentication algorithm and the first intermediate state to generate the second intermediate state. The IME engine 100 stores the second intermediate state in the local storage, the second intermediate state being associated with the re-transmitted second portion. The IME engine 100 generates the final authentication tag for the data burst after processing all portions of the data burst.

In a further embodiment, the IME engine 100 stores the second intermediate state by overwriting the first intermediate state when no errors are detected in the re-processing the re-transmitted second portion. In at least one embodiment, the portions are stored in parallel in a first-in-first-out (FIFO) buffer. In at least one embodiment, the FIFO buffer has a buffer depth representing a number of errors that can be handled while generating the final authentication tag for the data burst.

In a further embodiment, after re-processing the re-transmitted second portion, the IME engine 100 sends an acknowledgment signal to the sender node to indicate that a current authentication iteration has finished. The IME engine 100 overwrites the first intermediate state with the second intermediate state and removes the first portion from the FIFO buffer. In at least one embodiment, in response to detecting the error and before the processing the re-transmitted second portion has finished, the IME engine 100 refrains from sending the acknowledgment signal to the sender node to indicate that a current authentication iteration has finished.

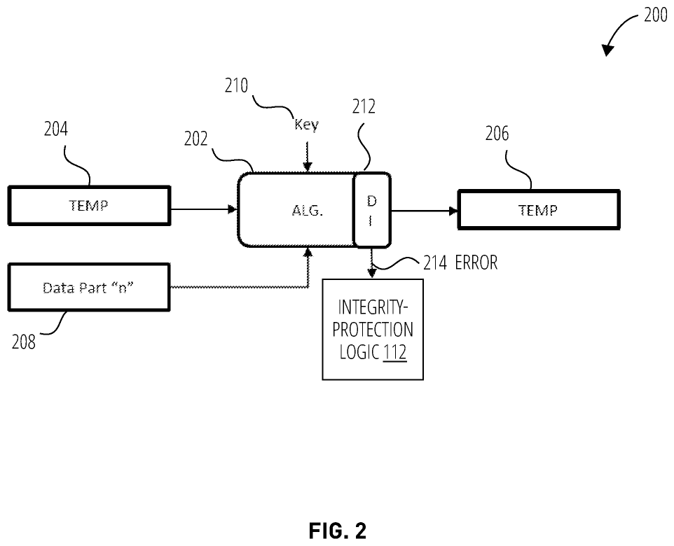

FIG. 2 is a block diagram illustrating an authentication iteration 200 of an authentication algorithm using integrity-protection logic according to at least one embodiment. The authentication algorithm can be implemented with one or more authentication units. As illustrated in FIG. 2, the authentication unit 202 is used in the authentication iteration 200. The authentication unit 202 is to perform an authentication function, such as the GHASH function. The authentication unit 202 can receive a current portion 208 of a data burst, a key 210, and a previous intermediate state 204. The current portion 208 can be a segment of a packet, a packet of a sequence of packets, or other segments of a data burst. The authentication unit 202 can compute a current intermediate state 206 using the key 210, current portion 208, and previous intermediate state 204. In a first authentication iteration 200, an IV, such as a zero value, can be provided to the authentication unit 202, instead of a previous intermediate state 204. A DI detector 212 can detect any DI error in the authentication operation. If the DI detector 212 detects an error in the authentication operation, the DI detector 212 can set an error flag 214 (or send an indication of the error to the integrity-protection logic 112).

In at least one embodiment, the current intermediate state 206 can be a variable called “TEMP.” The authentication unit 202 saves an intermediate authentication result in local storage, representing a partial authentication). If the DI detector 212 does not detect an error (i.e., the error flag 214 is not set), the TEMP can be overwritten with the intermediate authentication result, and the authentication unit 202 can compute the next part of the authentication. If the DI detector 212 identifies an error (i.e., the error flag is set), the authentication unit 202 can re-compute the previous part of the authentication using the last intermediate state, instead of starting from the beginning.

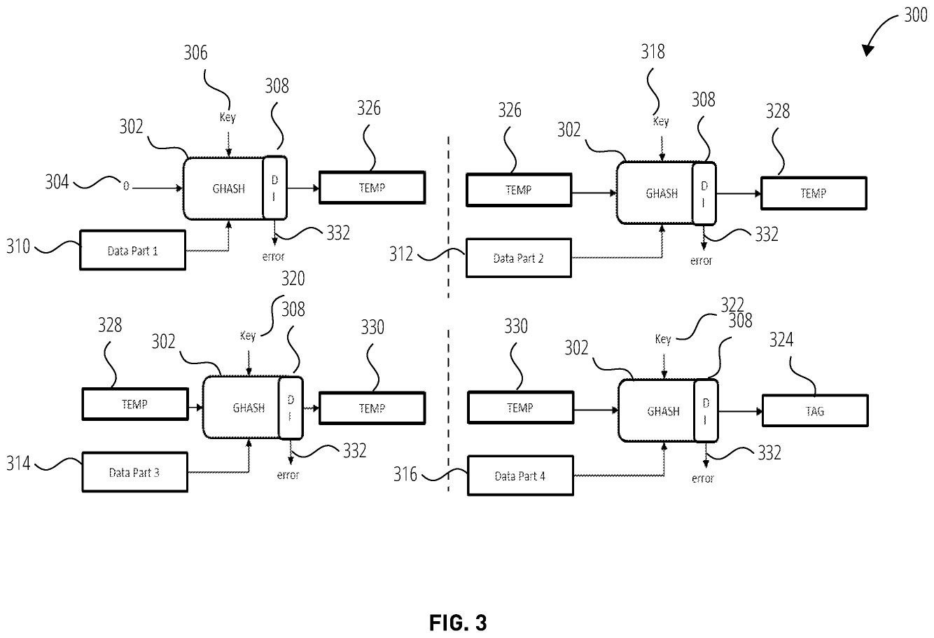

FIG. 3 is a block diagram illustrating multiple authentication iterations 300 of an authentication algorithm using integrity-protection logic according to at least one embodiment. The authentication algorithm can be implemented with one or more authentication units. As illustrated in FIG. 3, the authentication unit 302 is used in the multiple authentication iterations 300. In the first authentication iteration of the multiple authentication iterations 300, the authentication unit 302 can receive a first portion 310, an initial value 304, and a first key 306 to produce a first intermediate state 326. The first portion 310 can be a segment of a packet, a packet of a sequence of packets, or other segments of a data burst. In the first authentication iteration, the initial value 304 can be an IV, such as a zero value. A DI detector 308 can detect any DI error in the first authentication iteration. If the DI detector 212 detects an error in the first authentication iteration, the DI detector 308 can set an error flag 332 or send an indication of the error to the integrity-protection logic 112 (not illustrated in FIG. 3). The first intermediate state 326 can be stored in local storage. If the DI detector 308 does not detect an error (i.e., the error flag 332 is not set) in the first authentication iteration, the variable TEMP can be overwritten with the first intermediate state 326 for computing the next part of the authentication. If the DI detector 308 identifies an error (i.e., the error flag 332 is set) in the first authentication iteration, the authentication unit 202 can re-compute the first intermediate state after receiving the first portion 310 without any errors.

In a second authentication iteration of the multiple authentication iterations 300, the authentication unit 302 can receive a second portion 312, the first intermediate state 326 (the last intermediate state calculated by the authentication unit 302), and a second key 318 to produce a second intermediate state 328. The second portion 312 can be another segment of the packet, a packet of the sequence of packets, or another segment of the data burst. In the second authentication iteration, the authentication unit 302 receives the first intermediate state 326 instead of the initial value 304. The DI detector 308 can detect any DI error in the second authentication iteration. If the DI detector 308 detects an error in the second authentication iteration, the DI detector 308 can set an error flag 332 or send an indication of the error to the integrity-protection logic 112 (not illustrated in FIG. 3). The second intermediate state 328 can be stored in local storage. If the DI detector 308 does not detect an error (i.e., the error flag 332 is not set) in the second authentication iteration, the variable TEMP can be overwritten with the second intermediate state 328 for computing the next part of the authentication. If the DI detector 308 identifies an error (i.e., the error flag 332 is set) in the second authentication iteration, the authentication unit 202 can re-compute the second intermediate state 328 using the stored last intermediate state, instead of starting from the beginning. In this case, the last intermediate state is the first intermediate state 326. After receiving a re-transmitted (or re-retrieved) second portion 312, the authentication unit 302 can re-compute the second intermediate state 328 using the first intermediate state 326. If no errors are detected during the re-computation, the variable TEMP can be overwritten with the second intermediate state 328 for computing the next part of the authentication.

In a third authentication iteration of the multiple authentication iterations 300, the authentication unit 302 can receive a third portion 314, the second intermediate state 328 (the last intermediate state calculated by the authentication unit 302), and a third key 320 to produce a third intermediate state 330. The third portion 314 can be another segment of the packet, a packet of the sequence of packets, or another segment of the data burst. In the third authentication iteration, the authentication unit 302 receives the second intermediate state 328 instead of the initial value 304. The DI detector 308 can detect any DI error in the third authentication iteration. If the DI detector 308 detects an error in the third authentication iteration, the DI detector 308 can set an error flag 332 or send an indication of the error to the integrity-protection logic 112 (not illustrated in FIG. 3). The third intermediate state 330 can be stored in local storage. If the DI detector 308 does not detect an error (i.e., the error flag 332 is not set) in the third authentication iteration, the variable TEMP can be overwritten with the third intermediate state 330 for computing the next part of the authentication. If the DI detector 308 identifies an error (i.e., the error flag 332 is set) in the third authentication iteration, the authentication unit 202 can re-compute the third intermediate state 330 using the stored last intermediate state, instead of starting from the beginning. In this case, the last intermediate state is the second intermediate state 328. After receiving a re-transmitted (or re-retrieved) third portion 314, the authentication unit 302 can re-compute the third intermediate state 330 using the second intermediate state 328. If no errors are detected during the re-computation, the variable TEMP can be overwritten with the third intermediate state 330 for computing the next part of the authentication.

In a fourth authentication iteration of the multiple authentication iterations 300, the authentication unit 302 can receive a fourth portion 316, the third intermediate state 330 (the last intermediate state calculated by the authentication unit 302), and a fourth key 322 to produce a fourth intermediate state. The fourth portion 316 can be a final segment of the packet, a final packet of the sequence of packets, or a last segment of the data burst. Since the fourth portion 316 is the final portion, the fourth intermediate state is a final authentication tag 324. In the fourth authentication iteration, the authentication unit 302 receives the third intermediate state 330 instead of the initial value 304. The DI detector 308 can detect any DI error in the fourth authentication iteration. If the DI detector 308 detects an error in the fourth authentication iteration, the DI detector 308 can set an error flag 332 or send an indication of the error to the integrity-protection logic 112 (not illustrated in FIG. 3). The fourth intermediate state can be stored in local storage. If the DI detector 308 does not detect an error (i.e., the error flag 332 is not set) in the fourth authentication iteration, the variable TEMP can be overwritten with the fourth intermediate state for computing the final authentication tag 324. If the DI detector 308 identifies an error (i.e., the error flag 332 is set) in the fourth authentication iteration, the authentication unit 202 can re-compute the fourth intermediate state using the stored last intermediate state, instead of starting from the beginning. In this case, the last intermediate state is the third intermediate state 330. After receiving a re-transmitted (or re-retrieved) fourth portion 316, the authentication unit 302 can re-compute the fourth intermediate state using the third intermediate state 330. If no errors are detected during the re-computation, the variable TEMP can be overwritten with the fourth intermediate state for computing the final authentication tag 324.

FIG. 4 is a block diagram illustrating an authentication iteration 400 of an authentication algorithm with multiple authentication units and integrity-protection logic according to at least one embodiment. The authentication algorithm can be implemented with multiple authentication units 402, 404, 406, 408. Although four authentication units are illustrated in FIG. 4, other numbers of authentication units can be used. There are four DI detectors 440, 442, 444, 446, each operatively coupled to one of the authentication units 402, 404, 406, 408.

As illustrated in FIG. 4, the authentication units 402, 404, 406, 408 are used in the authentication iteration 400. Due to the chaining nature of the authentication algorithm, the authentication units 402, 404, 406, 408 can be organized in a pipeline. The first authentication unit 402 can receive an initial value 416 (e.g., a zero value), a first key 414, and a first portion 418 to produce a first intermediate state 420. The first portion 418 can be a segment of a packet, a packet of a sequence of packets, or other segments of a data burst. The first portion 418 can be stored in a packet storage of the integrity-protection logic 412. The first intermediate state 420 can be stored in an intermediate state storage of the integrity-protection logic 412. The second authentication unit 404 can receive the first intermediate state 420 and a second portion 424 to produce a second intermediate state 426. The second portion 424 can be another segment of the packet, another packet of the sequence of packets, or another segment of the data burst. The second portion 424 can be stored in the packet storage of the integrity-protection logic 412. The second intermediate state 426 can be stored in the intermediate state storage of the integrity-protection logic 412. The third authentication unit 406 can receive the second intermediate state 426, and a third portion 430 to produce a third intermediate state 432. The third portion 430 can be another segment of the packet, another packet of the sequence of packets, or another segment of the data burst. The third portion 430 can be stored in the packet storage of the integrity-protection logic 412. The third intermediate state 432 can be stored in the intermediate state storage of the integrity-protection logic 412. The fourth authentication unit 408 can receive the third intermediate state 432, and a fourth portion 436 to produce a fourth intermediate state 438. The fourth portion 436 can be another segment of the packet, another packet of the sequence of packets, or another segment of the data burst. In the illustrated embodiment, the fourth portion 436 is the last segment of the packet, the last packet of the sequence of packets, or the last segment of the data burst. The fourth portion 436 can be stored in the packet storage of the integrity-protection logic 412. The fourth intermediate state 438 can be stored in the intermediate state storage of the integrity-protection logic 412. The authentication algorithm can calculate a final authentication tag 410 based on the last intermediate state, i.e., the fourth intermediate state 438.

Since portions 418, 424, 430, 436, and intermediate states 420, 426, 432, and 438 are stored in the integrity-protection logic 412, the integrity-protection logic 412 can protect the authentication using the intermediate state in the event of an error. If any of the DI detectors 440, 442, 444, 446, detect an error, the integrity-protection logic 412 can use a last intermediate state to re-compute the current intermediate state, as described herein.

In at least one embodiment, the architecture of the integrity-protection logic 412 involves a closed-loop interaction between local DI-detection by DI detectors 440, 442, 444, 446, data-reception storage, and correctly computed intermediate computation states. The basic principle is storing incoming data (e.g., 418, 424, 430, 436) and updating the local ‘state’ storage in each new iteration without errors. If any one or more of the error flags are triggered, integrity-protection logic 412 uses the last intermediate state and data part to recalculate the erroneous GHASH iteration. As a result, no re-transmission is needed, and only one extra GHASH operation is needed. In some cases, the re-transmission of only the portion with the error is needed. In other embodiments, different computing blocks, such as encryption, other authentication schemes, SRAM, and I/O, can have errors that are detected by DI detectors.

In other embodiments, the architecture of the integrity-protection logic 412 can be implemented for a zero-latency penalty strategy. To accomplish that, the integrity-protection logic includes an additional “GHASH” function to run in parallel when an error occurs, such as illustrated in FIG. 5. In these embodiments, each intermediate state goes through the integrity-protection logic 412, so the re-computed intermediate result can be added back to the chain of events.

FIG. 5 is a block diagram illustrating an authentication iteration 500 of an authentication algorithm with multiple authentication units and integrity-protection logic with an additional authentication unit according to at least one embodiment. The authentication iteration 500 is similar to the authentication iteration 400, except the four authentication units 402, 404, 406, 408 in authentication iteration 500 output their intermediate states to integrity-protection logic 502. The integrity-protection logic 502 is similar to integrity-protection logic 412, except the integrity-protection logic 502 includes an additional authentication unit 504 to run in parallel when an error occurs. The architecture of the integrity-protection logic 502 can be implemented for a zero-latency penalty strategy.

FIG. 6 is a block diagram of integrity-protection logic 600 according to at least one embodiment. The integrity-protection logic 600 can be similar to the integrity-protection logic 112, integrity-protection logic 412, and integrity-protection logic 502 described above. The integrity-protection logic 600 can operate with a single authentication unit (e.g., a single GHASH unit) or multiple authentication units (e.g., an iterative approach). The integrity-protection logic 600 includes an error accumulator 602, a controller 604, an intermediate state storage 606, and a packet storage 608. The error accumulator 602 can monitor error flags set by any of the DI detectors in the IME engine. Each flag error from a DI detector can contain one or more error indicators. Alternatively, the error accumulator 602 can receive an indication of one or more errors from one or more DI detectors. The error accumulator 602 can include a logic gate (e.g., an OR gate with multiple inputs and a single output) that activates the controller 604 in response to any error being detected by the DI detectors. The intermediate state storage 606 can send or receive intermediate states 610 to or from the authentication unit(s). The packet storage 608 can receive incoming data portions 612 and provide the data portions 612 to the authentication unit(s). The controller 604 can control which intermediate states 610 and which data portions 612 are provided to the authentication unit(s). When there is no error, the controller 604 causes the intermediate state storage 606 to provide a current intermediate state to the authentication unit and the packet storage 608 to provide a current data portion to the authentication unit to compute a partial authentication result. When there is an error, the controller 604 causes the intermediate state storage 606 to provide a last intermediate state to the authentication unit and the packet storage 608 to provide a last data portion to the authentication unit to re-compute the partial authentication result. The controller 604 can send or refrain from sending an acknowledgment signal 614 to the authentication unit(s), where the acknowledgment signal 614 indicates that a current authentication iteration is completed. The controller 604 can refrain from sending the acknowledgment signal 614 in response to detecting an error by the error accumulator 602.

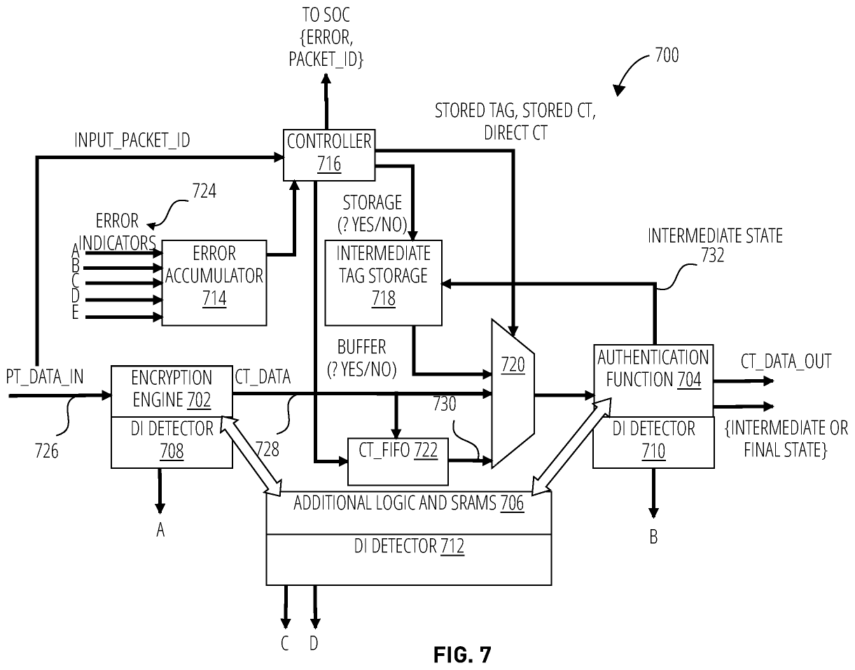

FIG. 7 is a block diagram of integrity-protection logic 700 according to at least one embodiment. The integrity-protection logic 700 is coupled between an encryption engine 702 and an authentication function 704. A DI detector 708 can monitor for errors by the encryption engine 702. The DI detector 708 can output an error indicator in response to detecting an error. A DI detector 710 can monitor for errors by the authentication function 704. The DI detector 710 can output an error indicator in response to detecting an error. A DI detector 712 can monitor for errors by additional logic and SRAMs 706, which are operatively coupled to the encryption engine 702 and authentication function 704. The DI detector 712 can output one or more indicators in response to detecting one or more errors. The error indicators 724 can be error flags, error signals, error bits, error messages, or the like.

In at least one embodiment, the integrity-protection logic 700 includes an error accumulator 714, a controller 716, an intermediate tag storage 718, a selection circuit 720 (e.g., multiplexer), and a FIFO buffer 722. The error accumulator 714 can receive one or more error indicators 724 from any of the DI detectors (e.g., 708, 710, 712, or others). In response to detecting an error, the error accumulator 714 can activate the controller 716. For example, the error accumulator 714 can send an activation signal to the controller 716.

The controller 716 can receive an input packet identifier of a current packet 726 input into the encryption engine 702 to be encrypted and authenticated. In at least one embodiment, the controller 716 can report an error with the packet identifier to a sender (e.g., a host over a host-side interface) in response to detecting an error. The reporting can cause the sender to re-send the packet having the error. The encryption engine 702 can receive the plaintext data of the current packet 726 and encrypt the plaintext data into current ciphertext data 728. The controller 604 can control whether the current ciphertext data 728 is stored in the FIFO buffer 722. For example, the controller 604 can send a control signal to the FIFO buffer 722 to store the current ciphertext data 728. The FIFO buffer 722 can store previous ciphertext data 730. The controller 716 can control the selection circuit 720 to select one of the current ciphertext data 728 or previous ciphertext data 730 from the FIFO buffer 722. The controller 716 can also control whether an intermediate tag storage 718 stores an intermediate state 732. The controller 604 can associate the input packet number with the current ciphertext data 728 in the FIFO buffer 722 and a last intermediate state in the intermediate tag storage 718. The controller 604 can control the selection circuit 720 to provide the correct intermediate state and the corresponding data to the authentication function 704. The authentication function 704 can receive the intermediate state and data from the selection circuit 720 and produce an intermediate state 732 of an authentication tag. In this manner, the intermediate state 732 is available in local storage for an intermediate state of hash computations to protect the authentication against errors occurring in error-prone computation steps, including encryption, authentication, SRAMs, I/Os, or the like. The intermediate IV can also be stored in local storage. Once the last data portion is received, the 704 can generate and output a final authentication tag.

In at least one embodiment, the controller 716 implements a control loop that can be activated at the time of error occurrence. In the control loop, the controller 716 can signal to a sender to re-send a packet or a portion of a packet corresponding to the error. In the control loop, the controller 716 can hold off the sender from sending new packets (or portions of the packet). In the control loop, the controller 716 causes incoming packets (or segments) to be stored in a first buffer (e.g., FIFO buffer 722) until the desired packet (or desired segment) arrives from the re-transmission. The control loop can store the last intermediate hash state computed without errors in a second buffer and resume the hash computation with the last intermediate hash state once the desired packet (or desired segment) arrives from the re-transmission. In the control loop, the controller 716 can continue the authentication tag computation by emptying the first buffer. In the control loop, the controller 716 can signal to the sender that the first buffer is empty and resume normal packet transmission. In this embodiment, the first buffer, FIFO buffer 722, can be used to maintain output data ordering.

In at least one embodiment, the controller 716 can determine an identification number (e.g., a sequence number), including a sequence count of the faulted packet. The controller 716 does not update the intermediate hash state corresponding to the faulted packet. The controller 716 can continue processing the incoming packets as normal with their corresponding identification numbers, updating the intermediate states, and sending out the encryption data. When the faulted packet re-arrives, the controller 716 can compute and update the intermediate state by considering the sequence number of the packet in the data sequence. In this embodiment, the controller 716 does not need the FIFO storage (e.g., FIFO buffer 722).

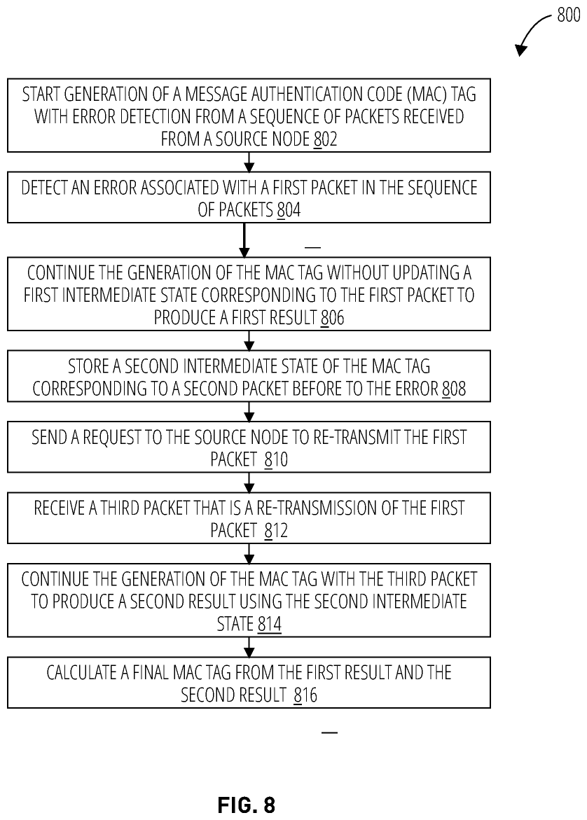

FIG. 8 is a flow diagram of a method 800 of storing and using intermediate states to protect the integrity of an authentication algorithm according to at least one embodiment. The method 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the IME engine 100 of FIG. 1 performs the method 800. In one embodiment, the integrity-protection logic 112 of FIG. 1 or FIG. 2 performs the method 800. In one embodiment, the integrity-protection logic 412 of FIG. 4 performs the method 800. In one embodiment, the integrity-protection logic 502 of FIG. 5 performs the method 800. In at least one embodiment, integrity-protection logic 600 of FIG. 6 performs the method 800. In at least one embodiment, integrity-protection logic 700 of FIG. 7 performs the method 800.

Referring to FIG. 8, the method 800 begins with the processing logic starting generation of a message authentication code (MAC) tag with error detection from a sequence of packets received from a source node (block 802). At block 804, the processing logic detects an error associated with a first packet in the sequence of packets. At block 806, the processing logic, in response to detecting the error, continues the generation of the MAC tag without updating a first intermediate state corresponding to the first packet to produce a first result. The processing logic stores a second intermediate state of the MAC tag corresponding to a second packet before the error (block 808). At block 810, the processing logic sends a request to the source node to re-transmit the first packet. At a subsequent time, the processing logic receives a third packet, a re-transmission of the first packet (block 812). At block 814, the processing logic continues the generation of the MAC tag with the third packet to produce a second result using the second intermediate state. The processing logic calculates a final MAC tag from the first result and the second result (block 816).

In a further embodiment, the processing logic determines an identification number of the packet in a sequence count for the sequence of packets. The processing logic generates the request with the identification number of the packet to send the request to the source node to re-transmit the packet. The processing logic continues processing incoming packets of the sequence of packets with their corresponding identification numbers and updating intermediate states corresponding to the incoming packets until the third packet arrives. The processing logic processes the third packet and updates the first intermediate state by considering the identification number of the packet in the sequence of packets.

In a further embodiment, the processing logic signals to the source node to hold off or prevent sending one or more subsequent packets in the sequence of packets. The processing logic stores one or more intervening packets in a buffer until the third packet arrives. The processing logic resumes a hash computation using the second intermediate state once the third packet arrives. The processing logic continues the hash computation with the one or more intervening packets stored in the buffer. The processing logic signals to the source node to continue sending the one or more subsequent packets in the sequence of packets.

In one embodiment, the second intermediate state includes an intermediate hash state of a hash computation and an IV. In another embodiment, the error is a DI error in at least one of an encryption computation, an authentication computation, an SRAM operation, or an I/O operation. In at least one embodiment, the generation of the MAC tag is performed in connection with an authentication algorithm that uses a hashing function to compute the MAC tag. In at least one embodiment, the authentication algorithm is the GMAC algorithm, and the hashing function is the GHASH function. Alternatively, other authentication algorithms and other hashing functions can be used.

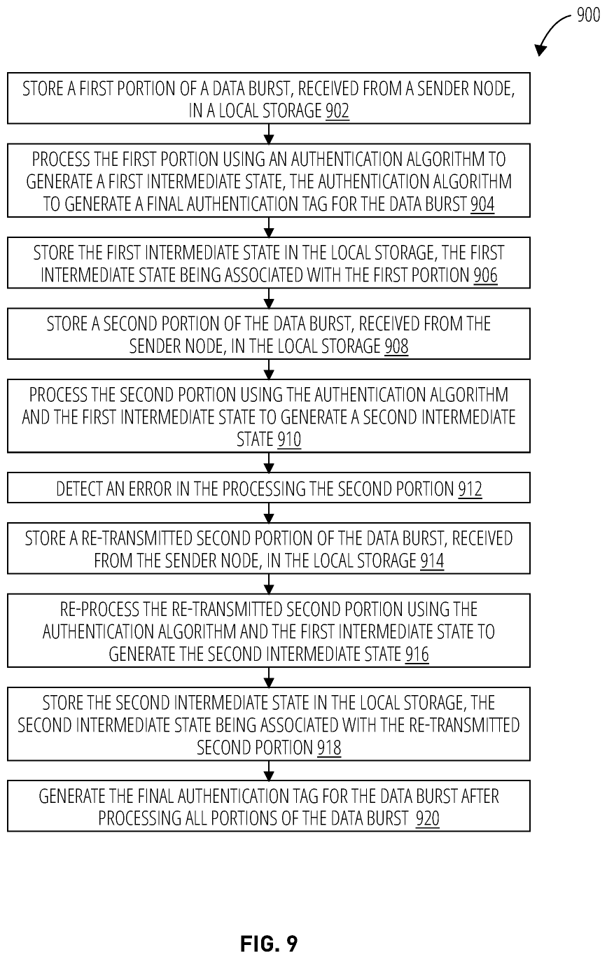

FIG. 9 is a flow diagram of a method 900 storing and using intermediate states to protect the integrity of an authentication algorithm according to at least one embodiment. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the IME engine 100 of FIG. 1 performs the method 900. In one embodiment, the integrity-protection logic 112 of FIG. 1 or FIG. 2 performs the method 900. In one embodiment, the integrity-protection logic 412 of FIG. 4 performs the method 900. In one embodiment, the integrity-protection logic 502 of FIG. 5 performs the method 900. In at least one embodiment, integrity-protection logic 600 of FIG. 6 performs the method 900. In at least one embodiment, integrity-protection logic 700 of FIG. 7 performs the method 900.

Referring to FIG. 9, the method 900 begins with the processing logic storing a first portion of a data burst, received from a sender node, in a local storage (block 902). At block 904, the processing logic processes the first portion using an authentication algorithm to generate a first intermediate state, the authentication algorithm to generate a final authentication tag for the data burst. At block 906, the processing logic stores the first intermediate state in the local storage, the first intermediate state being associated with the first portion. At block 908, the processing logic stores a second portion of the data burst, received from the sender node, in the local storage. At block 910, the processing logic processes the second portion using the authentication algorithm and the first intermediate state to generate a second intermediate state. At block 912, the processing logic detects an error in the processing of the second portion. At block 914, the processing logic stores a re-transmitted second portion of the data burst, received from the sender node, in the local storage. At block 916, the processing logic re-processes the re-transmitted second portion using the authentication algorithm and the first intermediate state to generate the second intermediate state. At block 918, the processing logic stores the second intermediate state in the local storage, the second intermediate state being associated with the re-transmitted second portion. At block 920, the processing logic generates the final authentication tag for the data burst after processing all portions of the data burst.

In a further embodiment, the processing logic stores the second intermediate state by overwriting the first intermediate state when no errors are detected in the re-processing the re-transmitted second portion. In at least one embodiment, the first portion and the re-transmitted second portion are stored in parallel in a FIFO buffer. In at least one embodiment, a depth of the FIFO buffer represents a number of errors that can be handled while generating the final authentication tag for the data burst.

In a further embodiment, after re-processing the re-transmitted second portion, the processing logic sends an acknowledgment signal to the sender node to indicate that a current authentication iteration has finished. The processing logic overwrites the first intermediate state with the second intermediate state. The processing logic removes the first portion from the FIFO buffer. In a further embodiment, in response to detecting the error and before the processing the re-transmitted second portion has finished, the processing logic refrains from sending the acknowledgment signal to the sender node to indicate that a current authentication iteration has finished.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. A method comprising:
starting generation of a message authentication code (MAC) tag with error detection from a sequence of packets received from a source node;
detecting an error associated with a first packet in the sequence of packets;
in response to detecting the error,
continuing the generation of the MAC tag without updating a first intermediate state corresponding to the first packet to produce a first result;
storing a second intermediate state of the MAC tag corresponding to a second packet before the error;
sending a request to the source node to re-transmit the first packet; and
receiving a third packet that is a re-transmission of the first packet;
continue the generation of the MAC tag with the third packet to produce a second result using the second intermediate state; and
calculating a final MAC tag from the first result and the second result.

2. The method of claim 1, further comprising:
determining an identification number of the first packet in a sequence count for the sequence of packets;
generating the request with the identification number of the packet to send the request to the source node to re-transmit the packet;
continuing processing incoming packets of the sequence of packets with their corresponding identification numbers and updating intermediate states corresponding to the incoming packets until the third packet arrives; and
processing the third packet and updating the first intermediate state by considering the identification number of the packet in the sequence of packets.

3. The method of claim 1, further comprising:
signaling to the source node to hold off sending one or more subsequent packets in the sequence of packets;
storing one or more intervening packets in a buffer until the third packet arrives;
resuming a hash computation using the second intermediate state once the third packet arrives;
continue the hash computation with the one or more intervening packets stored in the buffer; and
signaling to the source node to continue sending the one or more subsequent packets in the sequence of packets.

4. The method of claim 1, wherein the second intermediate state comprises an intermediate hash state of a hash computation and an intermediate initialization vector (IV).

5. The method of claim 1, wherein the error is a data integrity (DI) error in at least one of an encryption computation, an authentication computation, a static random access memory (SRAM) operation, or an input/output (I/O) operation.

6. The method of claim 1, wherein the generation of the MAC tag is performed in connection with an authentication algorithm that uses a hashing function to compute the MAC tag.

7. The method of claim 6, wherein the authentication algorithm is the Galois Message Authentication Code (GMAC) algorithm and the hash function is the GHASH function.

8. A method of operating a receiver node, the method comprising:
storing a first portion of a data burst, received from a sender node, in a local storage;
processing the first portion using an authentication algorithm to generate a first intermediate state, the authentication algorithm to generate a final authentication tag for the data burst;
storing the first intermediate state in the local storage, the first intermediate state being associated with the first portion;
storing a second portion of the data burst, received from the sender node, in the local storage;
processing the second portion using the authentication algorithm and the first intermediate state to generate a second intermediate state;
detecting an error in the processing the second portion;
storing a re-transmitted second portion of the data burst, received from the sender node, in the local storage;
re-processing the re-transmitted second portion using the authentication algorithm and the first intermediate state to generate the second intermediate state;
storing the second intermediate state in the local storage, the second intermediate state being associated with the re-transmitted second portion; and
generating the final authentication tag for the data burst after processing all portions of the data burst.

9. The method of claim 8, wherein storing the second intermediate state comprises overwriting the first intermediate state when no errors are detected in the re-processing the re-transmitted second portion.

10. The method of claim 8, wherein the first portion and the re-transmitted second portion are stored in parallel in a first-in-first-out (FIFO) buffer.

11. The method of claim 10, wherein a depth of the FIFO buffer represents a number of errors that can be handled while generating the final authentication tag for the data burst.

12. The method of claim 10, wherein, after re-processing the re-transmitted second portion, the method further comprises:
sending an acknowledgment signal to the sender node to indicate that a current authentication iteration has finished;
overwriting the first intermediate state with the second intermediate state; and
removing the first portion from the FIFO buffer.

13. The method of claim 12, wherein, in response to detecting the error and before the processing the re-transmitted second portion has finished, the method further comprises refraining from sending the acknowledgment signal to the sender node to indicate that a current authentication iteration has finished.

14. An inline memory encryption (IME) engine comprising:
encryption logic to receive segments of plaintext data of a data burst and output segments of cyphertext data of the data burst;
authentication logic to receive the segments of the cyphertext data, output an intermediate state corresponding to a respective segment of the cyphertext data, and output a final authentication tag associated with the data burst; and
integrity-protection logic coupled between the encryption logic and the authentication logic, the integrity-protection logic comprising:
an intermediate state storage to store a copy of a last intermediate state computed by the authentication logic; and
a packet storage to store a copy of one or more segments of the cyphertext data, wherein the integrity-protection logic is to:
receive an indication of an error associated with a current segment of the cyphertext data; and
cause the authentication logic to re-compute a current intermediate state associated with the current segment using the last intermediate state and the current segment of the cyphertext data without the error.

15. The IME engine of claim 14, wherein the authentication logic implements the Galois Message Authentication Code (GMAC) algorithm that uses a GHASH function to generate the final authentication tag.

16. The IME engine of claim 14, further comprising data-integrity (DI) detection logic to detect the error, wherein the error is a DI error in at least one of an encryption computation by the encryption logic, an authentication computation by the authentication logic, a static random access memory (SRAM) operation, or an input/output (I/O) operation.

17. The IME engine of claim 16, wherein the integrity-protection logic is further to:
hold sending an acknowledgment signal to a sender to indicate that a current authentication iteration is completed;
send a request to the sender to re-send the current segment; and
send the acknowledgment signal to the sender responsive to a determination that the re-computation of the current intermediate state is completed.

18. The IME engine of claim 14, wherein the authentication logic comprises a plurality of authentication units, each authentication unit of the plurality of authentication units to compute an intermediate state of a respective segment in an authentication iteration.

19. The IME engine of claim 18, wherein the integrity-protection logic comprises an additional authentication unit to re-compute the current intermediate state associated with the current segment using the last intermediate state and the current segment of the cyphertext data without the error.

20. The IME engine of claim 14, wherein the integrity-protection logic comprises:
an error accumulator to receive the indication of the error; and
a controller to control the intermediate state storage and the packet storage in response to the error.
